(19) United States
(12) Patent Application Publication
(10) Pub. No.: US 2022/0317604 A1
(43) Pub. Date: Oct. 6, 2022

(54) IMAGE FORMING APPARATUS

(71) Applicant: KYOCERA Document Solutions Inc., Osaka (JP)

(72) Inventors: Shunsaku FUJII, Osaka-shi (JP); Takashi EIKI, Osaka-shi (JP); Akihiro KONDO, Osaka-shi (JP); Yuta KITABAYASHI, Osaka-shi (JP); Rina KIKUGAWA, Osaka-shi (JP); Hiroki KAWASAKI, Osaka-shi (JP); Tei TO, Osaka-shi (JP); Ryohei TOKUNAGA, Osaka-shi (JP)

(73) Assignee: KYOCERA Document Solutions Inc., Osaka (JP)

(21) Appl. No.: 17/656,552

(22) Filed: Mar. 25, 2022

(30) Foreign Application Priority Data
Mar. 31, 2021 (JP) 2021-059984

(51) Int. Cl. G03G 15/20

(52) U.S. Cl. CPC G03G 15/2053

(57) ABSTRACT

An image forming apparatus includes a fixing section, a detection section, and a controller. The detection section detects a passing range of a recording medium in terms of a direction intersecting with a conveyance direction of the recording medium. A heating section of the fixing section includes a first heater and a second heater. The first heater has a longitudinal direction extending in an axis direction. The second heater has a longitudinal direction extending in terms of the axis direction from each of opposite ends of the first heater in terms of the axis direction. When a result of detection by the detection section indicates that the passing range of the recording medium does not overlap with a specific range of the second heater, the controller restricts heat generation by the second heater.

### INCORPORATION BY REFERENCE

The present application claims priority under 35 U.S.C. § 119 to Japanese Patent Application No. 2021-059984, filed on Mar. 31, 2021. The contents of this application are incorporated herein by reference in their entirety.

### BACKGROUND

The present disclosure relates to an image forming apparatus.

An image forming apparatus includes a fixing section including a heating belt (film). A heating section included in the fixing section has an electric conduction area whose width in the longitudinal direction thereof is changed according to the width of paper.

### SUMMARY

An image forming apparatus according to an aspect of the present disclosure includes an image forming section, a fixing section, a detection section, and a controller. The image forming section forms a toner image on a recording medium. The fixing section fixes the toner image to the recording medium. The detection section detects a passing range of the recording medium in terms of a specific direction intersecting with a conveyance direction of the recording medium. The controller controls operation of each of the image forming section and the fixing section. The fixing section includes a fixing belt with a cylindrical shape, a pressure member, and a heating section. The pressure member presses an outer circumferential surface of the fixing belt to form a fixing nip area, and rotates about a rotational axis thereof extending in parallel to the specific direction. The heating section is disposed opposite to an inner circumferential surface of the fixing belt, and heats the recording medium passing through the fixing nip area. The heating section includes a first heater and a second heater. The first heater has a longitudinal direction extending in an axis direction, the axis direction being parallel to the rotational axis of the pressure member. The second heater has a longitudinal direction extending in terms of the axis direction from each of opposite ends of the first heater in terms of the axis direction. When a result of detection by the detection section indicates that the passing range of the recording medium does not overlap with a specific range of the second heater, the controller restricts heat generation by the second heater.

### BRIEF DESCRIPTION OF THE DRAWINGS

FIG. 1 is a schematic diagram illustrating an example of the configuration of an image forming apparatus according to an embodiment.

FIG. 2 is a perspective view of an example of a fixing section.

FIG. 3 is a cross-sectional view taken along a line III-III in FIG. 2.

FIG. 4 is a plan view of a detailed example of the configuration of a heater.

FIG. 5 is a block diagram of an example of a control circuit of the image forming apparatus.

### DETAILED DESCRIPTION

The following describes an embodiment of the present disclosure with reference to the accompanying drawings. Note that elements that are the same or equivalent are indicated by the same reference signs in the drawings and description thereof is not repeated.

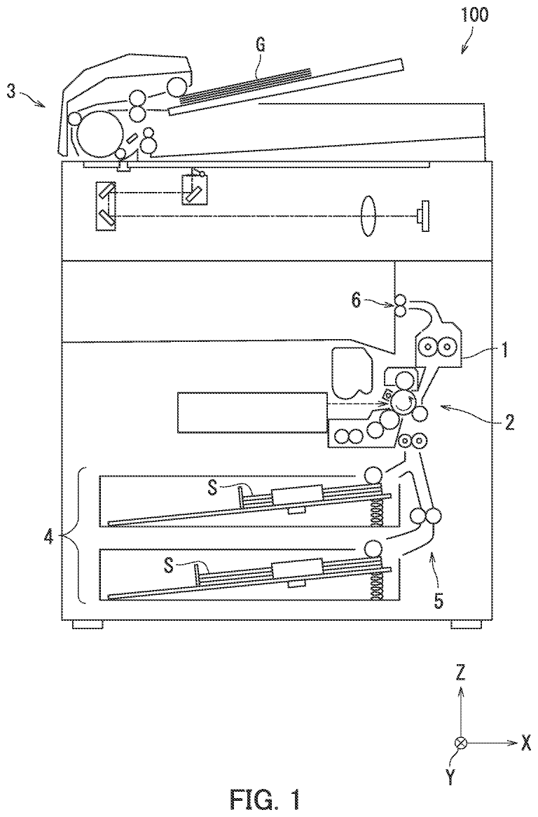

With reference to FIG. 1, an image forming apparatus 100 according to an embodiment will be described below. FIG. 1 is a schematic diagram illustrating an example of the configuration of the image forming apparatus 100. The image forming apparatus 100 is a copier, a printer, a facsimile machine, or a multifunction peripheral having functions of these, for example. The following describes an embodiment in a case in which the image forming apparatus 100 is a monochrome multifunction peripheral. Note that in FIG. 1, a direction from the left to the right is referred to as a positive X-axis direction, a direction from the front to the rear is referred to as a positive Y-axis direction, and a direction from the bottom to the top is referred to as a positive Z-axis direction for the sake of convenience.

As illustrated in FIG. 1, the image forming apparatus 100 includes a fixing section 1, an image forming section 2, a reading section 3, a feeding section 4, a conveyance section 5, and an ejection section 6.

The reading section 3 reads an image of a document G. The reading section 3 generates image data from the read image. The feeding section 4 accommodates a plurality of sheets S, and feeds the sheets S to the conveyance section 5 one at a time. The sheets S are made from paper or synthetic resin, for example. The conveyance section 5 includes a plurality of conveyance roller pairs, and conveys each sheet S to the image forming section 2. The sheet S corresponds to an example of a “recording medium”.

The image forming section 2 electrographically forms a toner image on the sheet S. The image forming section 2 includes a photosensitive drum, a charger, a light exposure device, a development device, a replenishment device, a transfer device, a cleaner, and a static eliminator. The toner image indicates the image of the document G, for example. The fixing section 1 applies heat and pressure to the toner image to fix the toner image to the sheet S. The conveyance section 5 conveys the sheet S with the toner image fixed thereto to the ejection section 6. The ejection section 6 ejects the sheet S out of the image forming apparatus 100.

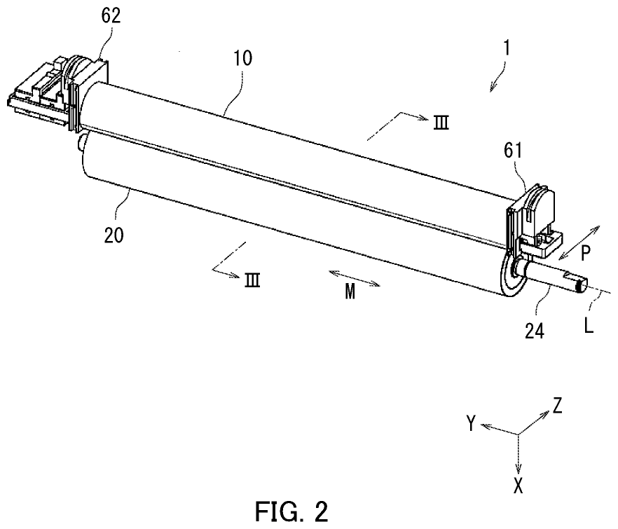

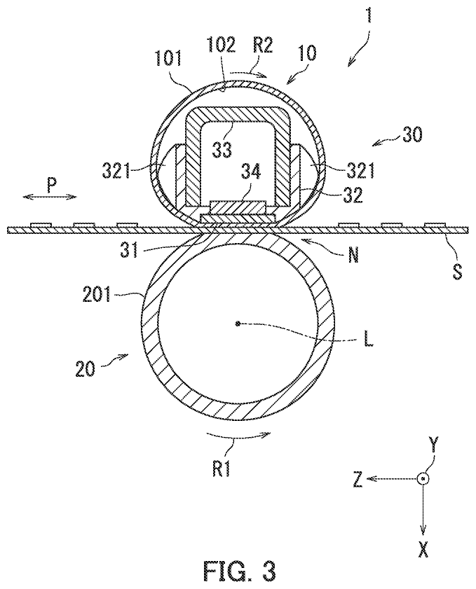

The configuration of the fixing section 1 will be described next with reference to FIGS. 2 and 3. FIG. 2 is a perspective view of an example of the fixing section 1. FIG. 3 is a cross-sectional view taken along a line III-III in FIG. 2.

As illustrated in FIGS. 2 and 3, the fixing section 1 includes a fixing belt 10, a pressure member 20, a heating section 30, a first belt holding member 61, and a second belt holding member 62.

The fixing belt 10 is a flexible cylindrical belt, and has an outer circumferential surface 101 and an inner circumferential surface 102. The pressure member 20 is a pressure roller, and has an elastic outer circumferential surface 201. The outer circumferential surface 201 of the pressure member 20 is in contact with the outer circumferential surface 101 of the fixing belt 10 to apply pressure to the fixing belt 10. As a result, a fixing nip area N is formed between the outer circumferential surface 101 of the fixing belt 10 and the outer circumferential surface 201 of the pressure member 20.

The pressure member 20 includes a core shaft 24. The core shaft 24 is driven by a non-illustrated drive mechanism to rotate the pressure member 20 about a rotational axis L of the pressure member 20. The pressure member 20 rotates anticlockwise in FIG. 3 in a first rotational direction R1. The fixing belt 10 follows the rotation of the pressure member 20 to rotate clockwise in FIG. 3 in a second rotational direction R2. The sheet S moves so as to pass through the fixing nip area N in a sheet passing direction P that intersects with an axis direction M that is parallel to the rotational axis L of the pressure member 20.

The heating section 30 includes a heater 31, a heater holding member 32, a reinforcing member 33, and a heat sensitive body 34, and is disposed opposite to the inner circumferential surface 102 of the fixing belt 10.

The heater 31 is in contact with the inner circumferential surface 102 of the fixing belt 10 to heat the fixing belt 10. The heater 31 is a ceramic heater with a thin and long shape with a length extending in the longitudinal direction thereof in parallel to the axis direction M and a width extending in the short direction thereof in parallel to the sheet passing direction P, for example.

The heater holding member 32 holds the heater 31. The heater holding member 32 is a heat-resistant resin member with a U-shape in cross section extending in terms of the axis direction M. The heater holding member 32 preferably includes ribs 321 for shaping the fixing belt 10.

The reinforcing member 33 is a metal frame stay member with a U-shape in cross section extending in terms of the axis direction M. The reinforcing member 33 is combined with the heater holding member 32 so as to reinforce the heater holding member 32.

The heat sensitive body 34 is in contact with the heater 31 through a through hole formed in the heater holding member 32 to sense the heat of the heater 31.

The fixing belt 10 has opposite ends in terms of the axis direction M that are held by the first belt holding member 61 and the second belt holding member 62.

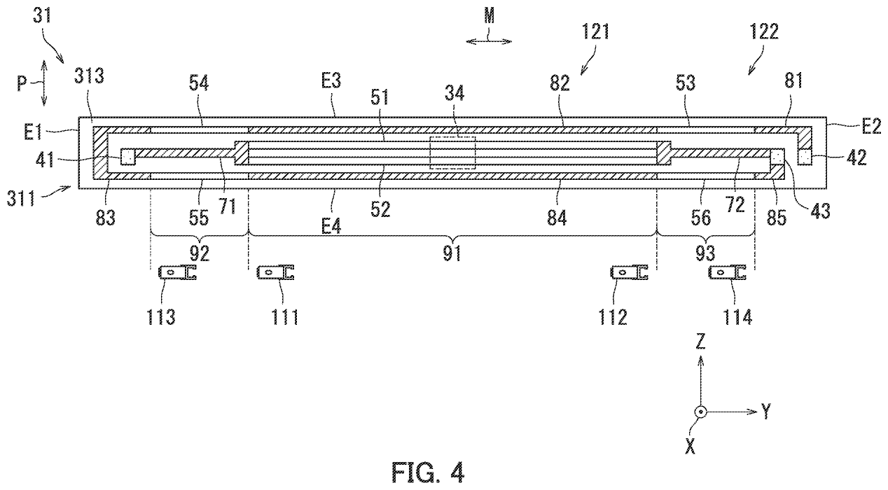

The configuration of the heater 31 will be described next in detail with reference to FIGS. 3 and 4. FIG. 4 is a plan view of a detailed example of the configuration of the heater 31.

As illustrated in FIG. 4, the heater 31 includes a substrate 311, a first individual electrode 41, a second individual electrode 42, and a common electrode 43. The heater 31 further includes a first partial heating element 51, a second partial heating element 52, a third partial heating element 53, a fourth partial heating element 54, a fifth partial heating element 55, and a sixth partial heating element 56.

The substrate 311 is a ceramic substrate, for example. The substrate 311 has two main surfaces parallel to each other. One of the two main surfaces serves as a heat generating surface 313 while the other serves as a non-heat generating surface.

The first individual electrode 41, the second individual electrode 42, the common electrode 43, and the first to sixth partial heating elements 51 to 56 each have a rectangular shape, and are disposed on the heat generating surface 313. The first partial heating element 51 and the second partial heating element 52 are connected in parallel to each other to serve as a center heating element 91 between the first individual electrode 41 and the common electrode 43. The third to sixth partial heating elements 53 to 56 are connected in series to one another as a first end heating element 92 and a second end heating element 93 between the second individual electrode 42 and the common electrode 43. The first to sixth partial heating elements 51 to 56 constitute one set of resistance heating elements having heating ranges appropriately settable according to the sheet width of the sheet S. The material of the first to sixth partial heating elements 51 to 56 is a resistance material such as silver palladium (Ag/Pd), for example. The material of the first individual electrode 41, the second individual electrode 42, and the common electrode 43 is a metal material with a higher electric conductivity than the first to sixth partial heating elements 51 to 56.

The first individual electrode 41 is disposed in the vicinity of one end E1 of the heat generating surface 313 in terms of the axis direction M. The second individual electrode 42 and the common electrode 43 are disposed in the vicinity of another end E2 of the heat generating surface 313 in terms of the axis direction M.

The heater 31 further includes a first conductor 71, a second conductor 72, a third conductor 81, a fourth conductor 82, a fifth conductor 83, a sixth conductor 84, and a seventh conductor 85.

The first partial heating element 51 and the second partial heating element 52 are disposed in parallel to each other at a substantial center of the heat generating surface 313 in terms of the axis direction M and the sheet passing direction P. The first conductor 71 electrically connects the first individual electrode 41 to each one end of the first and second partial heating elements 51 and 52 in terms of the axis direction M. The second conductor 72 electrically connects the common electrode 43 to each other end of the first and second partial heating elements 51 and 52 in terms of the axis direction M.

The third partial heating element 53 and the fourth partial heating element 54 are disposed in the vicinity of one end E3 of the heat generating surface 313 in terms of the sheet passing direction P. The fifth partial heating element 55 and the sixth partial heating element 56 are disposed in the vicinity of another end E4 of the heat generating surface 313 in terms of the sheet passing direction P. The third conductor 81 is bent in an L-shape, and electrically connects the second individual electrode 42 to the third partial heating element 53. The fourth conductor 82 linearly extends in terms of the axis direction M, and electrically connects the third partial heating element 53 to the fourth partial heating element 54. The fifth conductor 83 is bent in a C-shape, and electrically connects the fourth partial heating element 54 to the fifth partial heating element 55. The sixth conductor 84 linearly extends in terms of the axis direction M, and electrically connects the fifth partial heating element 55 to the sixth partial heating element 56. The seventh conductor 85 is bent in an L-shape, and electrically connects the sixth partial heating element 56 to the common electrode 43.

The center heating element 91 including the first partial heating element 51 and the second partial heating element 52 constitutes a first heater 121 disposed so that the longitudinal direction thereof extends in terms of the axis direction M. The first end heating element 92 includes the fourth partial heating element 54 and the fifth partial heating element 55, and the second end heating element 93 includes the third partial heating element 53 and the sixth partial heating element 56. The first end heating element 92 and the second end heating element 93 constitute a second heater 122 disposed so that the longitudinal direction thereof extends in terms of the axis direction M from the opposite ends of the first heater 121 in terms of the axis direction M.

The heat sensitive body 34 is supported on the side of the non-heat generating surface so as to be opposite to the center heating element 91 in order to sense the heat of the first heater 121. The heat sensitive body 34 includes a thermistor element, for example. The heat sensitive body 34 may further include a protective element such as a thermostat element. A thermostat element may be provided but no thermistors are provided on each of the first end heating element 92 and the second end heating element 93 on the side of the non-heat generating surface.

As further illustrated in FIG. 4, the image forming apparatus 100 further includes a first sheet sensor 111, a second sheet sensor 112, a third sheet sensor 113, and a fourth sheet sensor 114. The first to fourth sheet sensors 111 to 114 each detect passing or non-passing of the sheet S in a direction intersecting with a conveyance direction of the sheet S at the outside of a unit constituting the fixing section 1. Specifically, spot light is emitted from a light emitting section with a micro diameter. If a light receiving section receives the spot light reflected by the surface of the sheet S passing over a point opposite to the light emitting section, it is determined that passing has occurred. If the light receiving section does not detect the spot light, it is determined that passing has not occurred. The first to fourth sheet sensors 111 to 114 each correspond to an example of a “detection section”.

The first sheet sensor 111 is disposed at a location a predetermined distance (e.g., 10 mm) close to the center of the first heater 121 in terms of the axis direction M from one end of the first heater 121 in terms of the axis direction M. The first sheet sensor 111 detects passing or non-passing of the sheet S at the location. The first sheet sensor 111 corresponds to an example of a “first sensor”. The second sheet sensor 112 detects passing or non-passing of the sheet S at a location a predetermined distance close to the center of the first heater 121 in terms of the axis direction M from the other end of the first heater 121 in terms of the axis direction M. The second sheet sensor 112 corresponds to an example of a “second sensor”. The third sheet sensor 113 detects passing or non-passing of the sheet S at a location a predetermined distance close to the center of the first heater 121 in terms of the axis direction M from one end of the second heater 122 in terms of the axis direction M. The third sheet sensor 113 corresponds to an example of a “third sensor”. The fourth sheet sensor 114 detects passing or non-passing of the sheet S at a location a predetermined distance close to the center of the first heater 121 in terms of the axis direction M from the other end of the second heater 122 in terms of the axis direction M. The fourth sheet sensor 114 corresponds to an example of a “fourth sensor”.

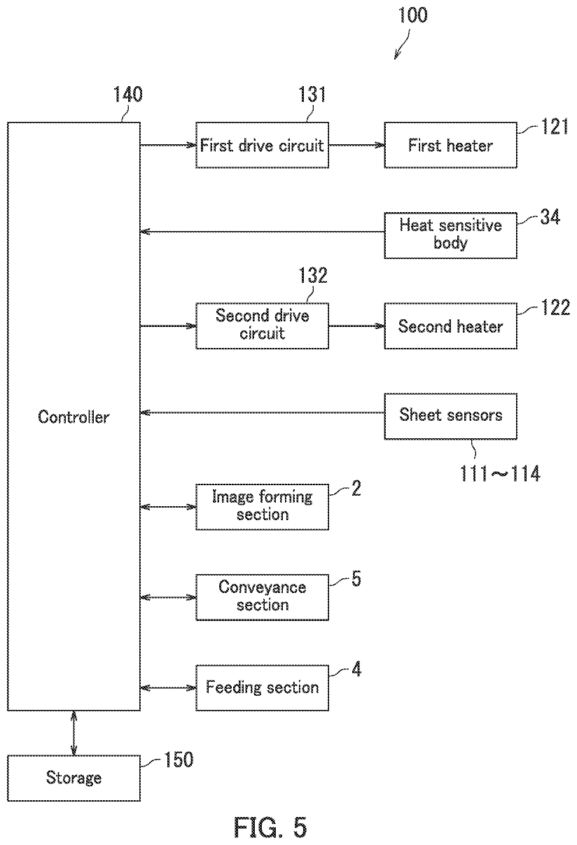

A configuration of a control circuit of the image forming apparatus 100 will be described next with reference to FIGS. 1 to 5. FIG. 5 is a block diagram of an example of the control circuit of the image forming apparatus 100.

As illustrated in FIG. 5, the image forming apparatus 100 further includes a first drive circuit 131, a second drive circuit 132, a controller 140, and storage 150.

The storage 150 includes a storage device, and stores data and computer programs therein. The storage 150 includes a main storage device such as semiconductor memory and an auxiliary storage device such as a hard disk drive.

The controller 140 includes a processor such as a central processing unit (CPU), and executes the computer programs stored in the storage 150 to control each element of the image forming apparatus 100. Specifically, the controller 140 controls each operation of the feeding section 4, the conveyance section 5, and the image forming section 2. Furthermore, the controller 140 receives output from the heat sensitive body 34, and receives output of each of the first to fourth sheet sensors 111 to 114. In addition, the controller 140 drives the first heater 121 via the first drive circuit 131 and drives the second heater 122 via the second drive circuit 132 to control the operation of the fixing section 1.

The controller 140 controls each of input power to the first heater 121 and input power to the second heater 122 according to a detected temperature detected by the heat sensitive body 34 so that the detected temperature matches with a target temperature. However, when each output of the first to fourth sheet sensors 111 to 114 indicates that a passing range of the sheet S does not overlap with a specific range of the second heater 122, the controller 140 restricts heat generation by the second heater 122. For example, when the first sheet sensor 111 and the second sheet sensor 112 each detect passing of the sheet S while the third sheet sensor 113 and the fourth sheet sensor 114 each detect non-passing of the sheet S, it is determined that the sheet S has a small sheet width. In this case, the controller 140 restricts power input to the second heater 122 so as to suppress an excessive temperature increase of the second heater 122.

Furthermore, when each output of the first to fourth sheet sensors 111 to 114 indicates that the passing range of the sheet S does not overlap with a specific range of the first heater 121, the controller 140 suspends power input to the second heater 122 and restricts heat generation by the first heater 121. For example, when each of the first to fourth sheet sensors 111 to 114 detects non-passing of the sheet S, it is determined that the sheet S has a further small sheet width. In this case, the controller 140 turns off the second heater 122 and restricts power input to the first heater 121 so as to suppress an excessive temperature increase of the first heater 121.

By contrast, when the first to fourth sheet sensors 111 to 114 each detect passing of the sheet S, it is determined that the sheet has a relatively large sheet width. In this case, the controller 140 supplies sufficiently large input power not only to the first heater 121 but also to the second heater 122.

Note that the controller 140 may energize the heater 31 only in a period in which the sheet S passes through the fixing nip area N. When each output of the first to fourth sheet sensors 111 to 114 indicates that the passing range of the sheet S does not overlap with the specific range of the first heater 121 or the second heater 122, the controller 140 executes sheet interval increasing control. That is, the controller 140 controls each operation of the feeding section 4, the conveyance section 5, and the image forming section 2 so as to increase the distance (sheet interval) between a first sheet and a second sheet sequentially supplied from the image forming section 2 to the fixing section 1. As a result, an excessive temperature increase of each of the first heater 121 and the second heater 122 can be suppressed.

According to the above embodiment, the image forming apparatus 100 can perform on the fixing section 1 temperature control by which an excessive temperature increase at a non-sheet passing part is suppressed even with a limited number of heat sensitive bodies 34.

An Embodiment of the present disclosure has been described so far with reference to the drawings. However, the present disclosure is not limited to the above embodiment, and may be implemented in various manners within a scope not departing from the gist thereof. Various disclosures can be formed by appropriately combining elements of configuration indicated in the above embodiment. For example, some elements of configuration may be omitted from all the elements of configuration indicated in the embodiment. The drawings schematically illustrate elements of configuration in order to facilitate understanding. Properties such as the number of the elements of configuration illustrated in the drawings may differ from actual properties thereof in order to facilitate preparation of the drawings. Furthermore, each element of configuration indicated in the above embodiment is an example and not a particular limitation. Various alterations may be made so long as there is no substantial deviation from the effects of the present disclosure.

What is claimed is:

1. An image forming apparatus comprising:
an image forming section configured to form a toner image on a recording medium;
a fixing section configured to fix the toner image to the recording medium;
a detection section configured to detect a passing range of the recording medium in terms of a specific direction intersecting with a conveyance direction of the recording medium, the passing range of the recording medium being an extent of the recording medium passing through the fixing section in terms of the specific direction; and
a controller configured to control operation of each of the image forming section and the fixing section, wherein
the fixing section includes:
a fixing belt with a cylindrical shape;
a pressure member that presses an outer circumferential surface of the fixing belt to form a fixing nip area and that rotates about a rotational axis thereof extending in parallel to the specific direction; and
a heating section that is disposed opposite to an inner circumferential surface of the fixing belt and that heats the recording medium passing through the fixing nip area,
the heating section includes:
a first heater with a longitudinal direction extending in an axis direction, the axis direction being parallel to the rotational axis of the pressure member; and
a second heater with a longitudinal direction extending in terms of the axis direction from each of opposite ends of the first heater in terms of the axis direction,
when a result of detection by the detection section indicates that the passing range of the recording medium does not overlap with a specific range of the second heater, the controller restricts heat generation by the second heater.

2. The image forming apparatus according to claim 1, wherein
the detection section includes:
a first sensor that detects passing or non-passing of the recording medium at a location a predetermined distance close to a center of the first heater from one end of the first heater in terms of the axis direction;
a second sensor that detects passing or non-passing of the recording medium at a location a predetermined distance close to the center of the first heater from another end of the first heater in terms of the axis direction;
a third sensor that detects passing or non-passing of the recording medium at a location a predetermined distance close to the center of the first heater from one end of the second heater in terms of the axis direction; and
a fourth sensor that detects passing or non-passing of the recording medium at a location a predetermined distance close to the center of the first heater from another end of the second heater in terms of the axis direction.

3. The image forming apparatus according to claim 1, wherein
the fixing section further includes a heat sensitive body that senses heat of the first heater, and
the controller controls power input to the first heater and power input to the second heater according to a temperature detected by the heat sensitive body.

4. The image forming apparatus according to claim 1, wherein
when the result of detection by the detection section indicates that the passing range of the recording medium does not overlap with the specific range of the second heater, the controller controls the operation of the image forming section so as to increase an interval between a first sheet of the recording medium and a second sheet of the recording medium sequentially supplied from the image forming section to the fixing section.

5. The image forming apparatus according to claim 1, wherein
when the result of detection by the detection section indicates that the passing range of the recording medium does not overlap with a specific range of the first heater, the controller controls the operation of the image forming section to increase an interval between a first sheet of the recording medium and a second sheet of the recording medium sequentially supplied from the image forming section to the fixing section.
